(19) United States
(12) Patent Application Publication
(10) Pub. No.: US 2002/0084132 A1
(43) Pub. Date: Jul. 4, 2002

(54) Tractor frame

(75) Inventors: Matthew J. Plas, Elyria, OH (US); Martin E. Pierce, North Royalton, OH (US)

Correspondence Address: Roger D. Emerson, Emerson & Associates, 4421 Ranchwood Spur, Akron, OH, 44333-1343, US

(73) Assignee: MTD PRODUCTS INC, Cleveland, OH (US)

(21) Appl. No.: 09/745,709

(22) Filed: Dec. 21, 2000

Related U.S. Application Data
(60) Provisional application No. 60/201,096, filed on May 2, 2000.

(51) Int. Cl. B60K 7/00; B60K 5/00

(52) U.S. Cl. 180/291; 180/311

(57) ABSTRACT

A riding mower frame is provided which is adapted to receive various types and sizes of transmissions and engines. The frame has an adjustable engine mounting plate for supporting a first engine that can be of any size or type chosen with sound engineer or judgment. The adjustable mounting plate may also be adjusted to, alternatively, support a second engine that can also be of any size or type chosen with sound engineer and judgment. Furthermore, the frame has two transmission mounting plates with generic mounting surfaces for supporting a first transmission that can be of any size or type chosen within sound engineering judgment. The generic mounting surfaces may, alternatively, support a second transmission that can also be of any size or type chosen with sound engineering judgment.

This application claims priority from Provisional Patent Application Serial No. 60/201,096, filed May 02, 2000.

### FIELD OF INVENTION

The present invention relates to a vehicle frame, and in particular to a riding lawn mower frame adapted to receive various types and sizes of transmissions and engines.

### BACKGROUND OF THE INVENTION

A major component of vehicles, such as riding lawn mowers, is the frame upon which all other elements are assembled. Typically, a riding mower frame has three general components including: a front frame section onto which the engine is secured, a rear frame section which houses the transmission and a center frame section including a bell housing which receives the drive shaft components linking the engine to the transmission. These frame sections are static in the sense that they cannot receive a plurality of transmission and engine types, but are designed for a specific configuration of power train. A different frame, including front, rear and center frame sections, is needed in order to incorporate different engines or transmissions onto a single frame.

It would therefore be advantageous to have a mower frame that could be adapted to receive a power train selectively configured to have different operating characteristics. In other words, the riding mower frame could be adapted to receive one of a plurality of different engine types having different output capacities or mounting configurations without modifying the frame itself. Likewise, the mower frame could be adapted to receive one of a plurality of different transmissions, each having different operating parameters, thus allowing for a selectively configurable power train without substantially altering the mower frame.

### SUMMARY OF THE INVENTION

It is therefore an object of the present invention to provide a mower that includes a frame having an adjustable engine mounting plate for use in selectively supporting one of a plurality of engines, wherein the engines have different operating characteristics.

It is also an object of the present invention to provide a mower frame that can receive one of a plurality of different transmissions, wherein is included transmission mounting plates adapted to fixedly fastened one of the transmissions to the mower frame.

According to the present invention, a riding mower frame is provided which is adapted to receive various types and sizes of transmissions and engines. The frame may include an adjustable engine mounting plate for supporting a first engine that can be of any size or type chosen with sound engineering or judgment. The mower frame may also be selectively, alternatively, used to support a second engine having a different configuration or power output capacity. Furthermore, the frame has a plurality of transmission mounting plates with generic mounting surfaces for supporting a first transmission, which can be of any size or type chosen within sound engineering judgment. The generic mounting surfaces are adapted to also support a second transmission having a different configuration or operating characteristics.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, a preferred embodiment of which will be described in detail in this specification and illustrated in the accompanying drawings which form a part hereof and herein:

FIG. 1 is a side view of a mower incorporating the present invention.

FIG. 2 is perspective view of the mower frame showing the adjustable engine mounting plate.

FIG. 3 is a perspective view of the left-hand transmission mounting plate.

FIG. 4 is a perspective view of a transmission and corresponding left and right hand mounting plates.

FIG. 5 is an exploded perspective view of a transmission, mounting plates and mower frame.

### DESCRIPTION OF THE PREFERRED EMBODIMENT

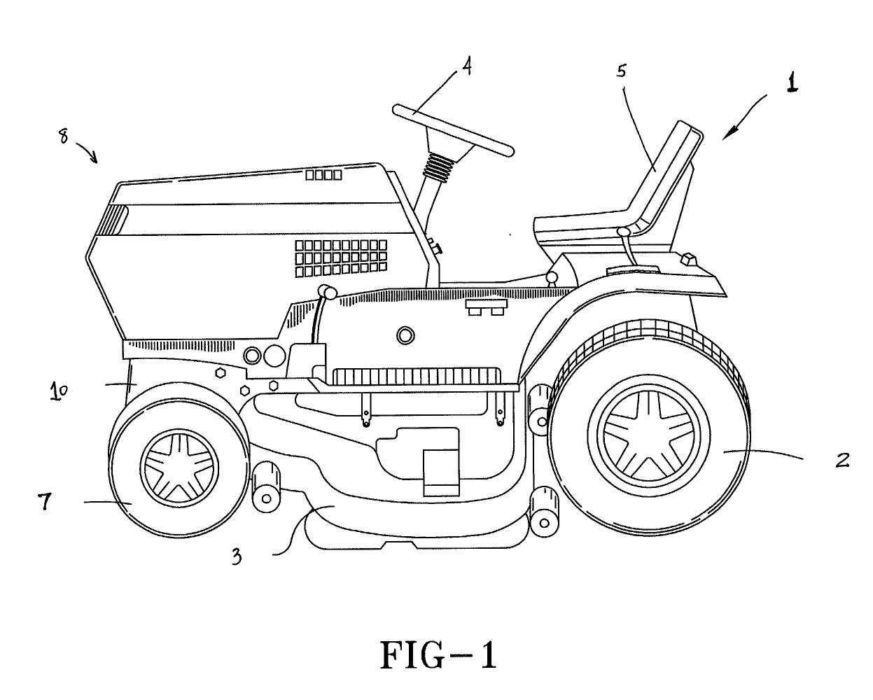

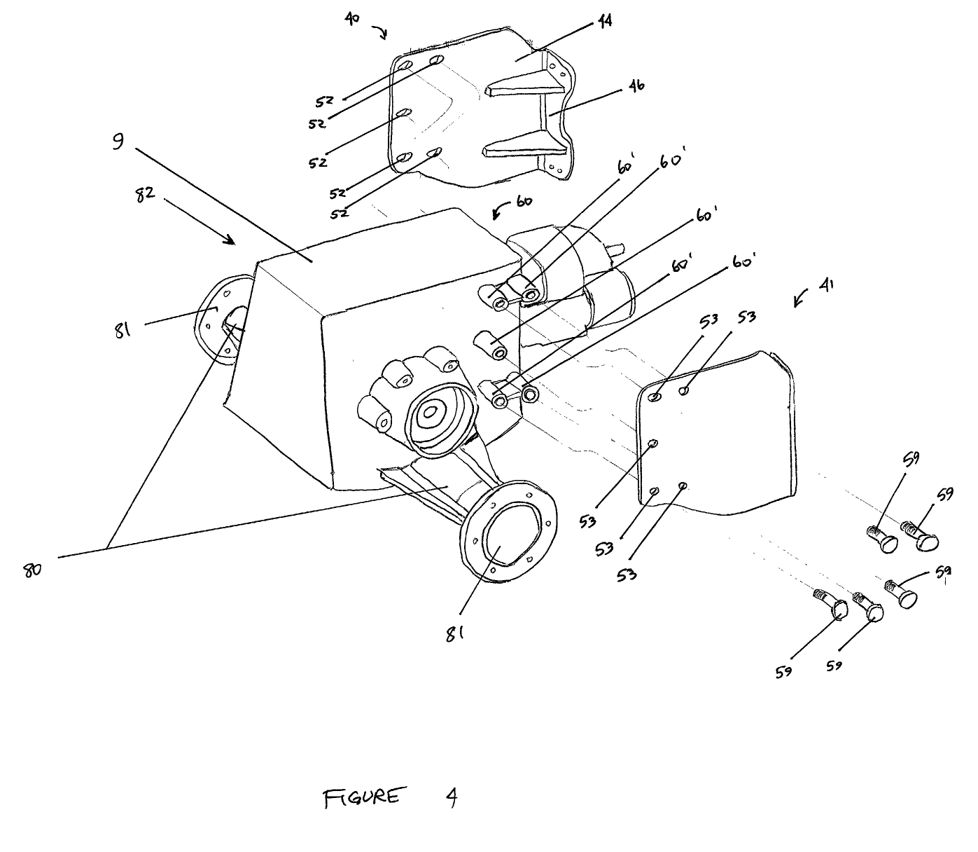

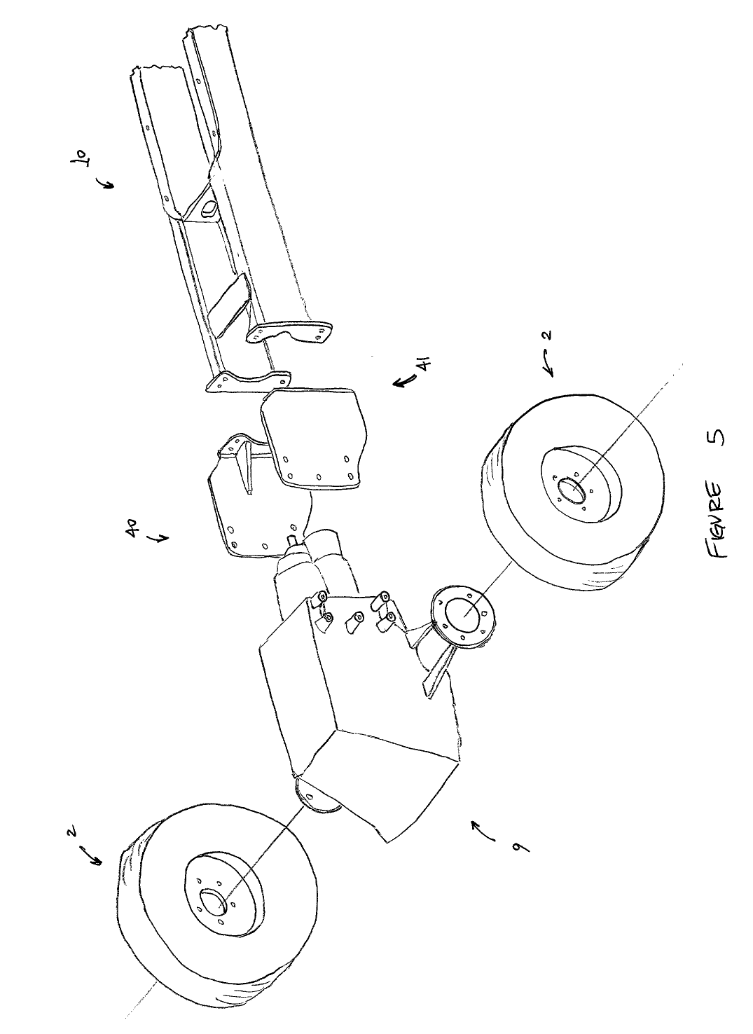

Referring now to the drawings wherein the showings are for purposes of illustrating a preferred embodiment of the invention only and not for purposes of limiting the same, FIG. 1 depicts a riding vegetation mower shown generally at 1. The mower 1 has two rear ground engaging wheels 2, a mower deck 3, a steering wheel 4, an operator seat 5, an engine 8 and a frame member 10. Additionally, the mower 1 includes a transmission 9, shown in FIGS. 4 and 5. The mower 1 also has two front ground engaging wheels 7 in operative connection with the steering wheel 4 for use in steering the riding mower. It is noted that in the preferred embodiment the invention described herein pertains to a riding lawn mower. However, the present invention is also applicable to any vehicle having a vehicle frame, an engine and a transmission wherein it is desired to change the power train configuration without substantially altering the vehicle frame components.

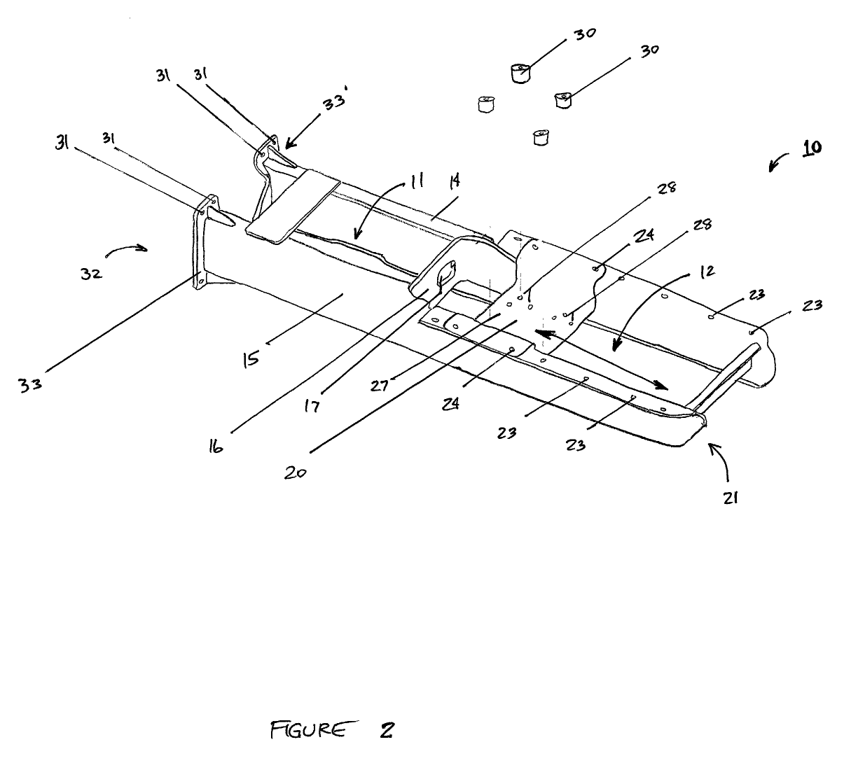

With reference now to FIG. 2, the frame member 10 of the mower 1 is shown in a perspective view. The frame member 10 is generally elongate having first and second interior regions 11, 12. The regions are defined by first and second side members 14, 15 and a cross member 16 which separating the first interior region 11 from the second interior region 12. The cross member 16 has a hole 17 fashioned therein through which is received drive shaft components, not shown, which operatively connect the engine 8 to the transmission 9, as will be further discussed in a subsequent paragraph.

With continued reference to FIG. 2, an engine-receiving member 20 is shown received by the first and second side members 14, 15 at a first end 21 of the frame member 10. It should be noted that an engine-receiving member is not required for this invention (the engine could be directly attached to the frame.) However, an engine-receiving member is preferred and to be used as will now be described. The engine-receiving member 20 is formed such that the body 27 of the engine-receiving member 20 at least partially resides within the second interior region 12. In the preferred embodiment, the engine-receiving member 20 is longitudinally adjustable along the side members 14, 15, in the direction of the arrow, such that the engine-receiving member 20 may be selectively attached at a plurality of points to the side members 14, 15, by way of the mounting holes 23 fashioned within the side members 14, 15. The engine-receiving member 20 in a similar manner has holes 24 fashioned therein on opposite ends for concentrically aligning with the holes 23 of the side members 14, 15 for use in receiving fastening means. Any such means of fastening the engine-receiving member 20 to the side members 14, 15 may be chosen with sound engineering judgment. Additionally, the engine-receiving member 20 has holes 28 fashioned in the body 27 for use in securing one of a plurality of engines 8, 8′ to the engine-receiving member 20. In the preferred embodiment, vibration isolation pads 30 are included and disposed between the engine 8, not shown in FIG. 2, and the engine-receiving member 20. Any such fastening means for fastening the engine 8 to the engine-receiving member 20 may be chosen with sound engineering judgment such that the vibration isolation pads 30 are fixedly disposed there between.

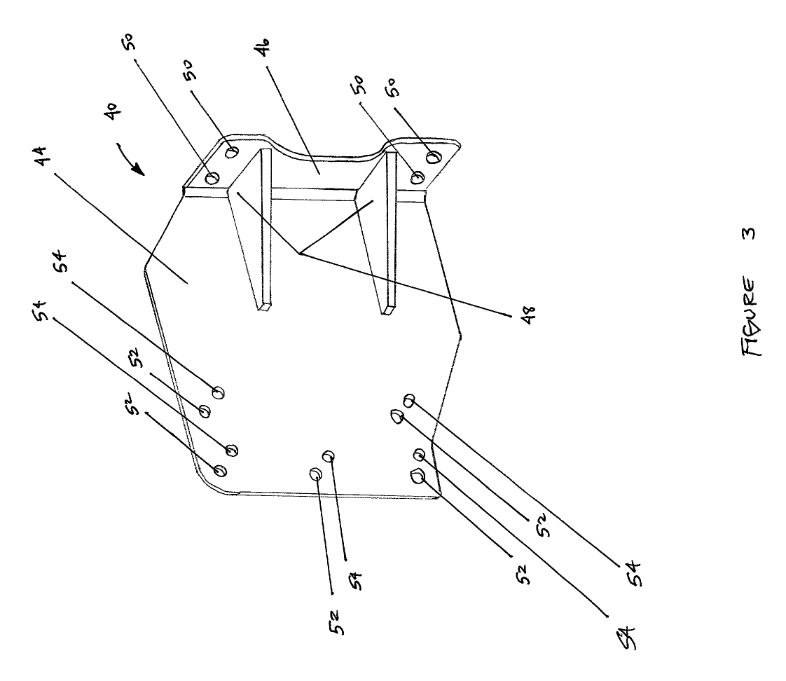

With reference to FIG. 3, a left hand transmission mounting plate is depicted, shown generally at 40. The mounting plate 40 has a matching mirror-image right hand mounting plate 41, shown in FIGS. 4 and 5. In the description presented herein, it should be construed, that components and attributes assigned to the left hand mounting plate 40 will have matching mirror-image components assigned to the right hand mounting plate 41 accordingly. Therefore a detailed description of the right hand mounting plate 41 will not be offered here, but it is understood that when referring to a component of the left hand mounting 40, a mirror image of the same component is included in the right hand mounting plate 41. The mounting plate 40 has a first generally planar portion 44 and a second portion 46 extending substantially perpendicular to the first portion 44. Gussets 48 reinforce the rigidity between the first and second portions 44, 46 of the mounting plate 40. In the preferred embodiment, the gussets 48 are welded to the first and second portion 44, 46 of the mounting plate 40. However, any such means of fastening the gussets 48 to the mounting plate 40 may be chosen with sound engineering judgment.

With continuing reference to FIGS. 2 and 3, the second portion 46 of the mounting plate 40 has fashioned therein a single pattern of holes 50, which are included to concentrically align with holes 31 fashioned at the second end 32 of the frame member 10, as shown in FIG. 2. FIG. 2 depicts receiving plates 33, 33′ fixedly attached to the side members 14, 15 respectively. In this manner, holes 31 fashioned in the receiving plates 33, 33′ provide a means by which the mounting plates 40 and 41 may be fixedly attached to the frame member 10 via the holes 50. In the preferred embodiment bolts are inserted into the concentrically aligned holes 31 and 50 and matching nuts are fastened thereto for use in fixedly securing the mounting plates 40, 41 and 33, 33′ together. However any such means of fastening the mounting plates 40, 41 to the receiving plates 33, 33′ may be chosen with sound engineering judgment.

With reference now to FIGS. 3 and 4, holes 52 are fashioned in the first portion 44 of the left hand mounting plate 40. Likewise, holes 53 are fashioned in the right hand mounting plate, shown in FIG. 4. The pattern of holes 52, 53 correspond respectively to bolt receiving members 60, 60′ fashioned on opposite sides of transmission 9. The holes 52, 53 receive fastening bolts 59 that thread into the bolt receiving members 60, 60′ for use in fixedly attaching the mounting plates 40, 41 to the transmission 9. In one embodiment, an alternate set of holes 54, 54′, holes 54′ not shown, are fashioned in the mounting plates 40, 41 for use in selectively attaching the mounting plates 40, 41 to one of a plurality of transmissions 9. In another embodiment, alternate mounting plates, not shown, have a singular pattern of holes 52, fashioned therein for use in attaching to a specific transmission 9. In this manner, installing different transmissions onto the mower 1 necessitates installing different mounting plates that specifically match the bolt receiving members 60 of that particular transmission 9. In all embodiments, the holes 31 fashioned in the second portion 46 of the mounting plate 40 are substantially identical for use in aligning with the holes 31 of the frame member 10.

With continued reference to FIG. 4, the transmission 9 includes axles 80 and wheel hubs 81. The wheel hubs 81 receive ground engaging wheels 2 for use in providing mobility to the mower 1. In that wheels 2, shown in FIG. 5, wheel hubs 81 and axles 80 are well known in the art, no further explanation will be offered at this point. In this manner, the transmission housing 82 comprises a sufficiently strong and rigid member that when attached to the frame member 10 via the mounting plates 40, 41, comprises the entire structure upon which all of the components of the mower 1 are mounted.

Referring now to FIGS. 1 through 5, according to the present invention, an engine 8 is selectively chosen, having specific operating characteristics, from a plurality of engines 8, 8′, 8″, etc. wherein the engines 8, 8′, 8″, etc. have mounting characteristics compatible with the engine-receiving member 20 and frame member 10. The selected engine 8 is then installed onto the engine-receiving 20 with the isolation pads 30 disposed there between. The engine-receiving member 20 may then be longitudinally adjusted along the frame member 10 as is appropriate to the selected engine 8. The means for fixedly securing the engine-receiving member 20 to the frame member 10 is then engaged. Additionally, a transmission 9 is selectively chosen, having specific operating characteristics, from a plurality of transmissions 9, 9′, 9″, etc. wherein the transmissions 9, 9′, 9″, etc. have mounting characteristics compatible with the mounting plates 40, 41. The mounting plates 40, 41 are then fixedly secured to the selected transmission 9, in the manner previously described. In turn, the mounting plates 40, 41, with the transmission 9 attached, are fixedly secured to the frame member 10 at the second end 32 with appropriate fastening means, not shown. Still further, the drive shaft components, not shown, are installed onto the selected engine 8 and selected transmission 9 in a manner well known in the art. Thus, a selectively alterable power train is assembled onto a mower frame without substantially altering the frame of the mower. It is expressly noted that the order in which the engine 8 and transmission 9 and drive shaft components are installed onto the frame member 10 may vary in a manner well known in the art.

The invention has been described with reference to preferred embodiment. Obviously, modifications and alterations will occur to others upon a reading and understanding of this specification. It is intended to include all such modifications and alternations in so far as they come within the scope of the appended claims or the equivalence thereof.

What is claimed is:

1. A vehicle, comprising:
a frame member;
a first engine selectively received by said frame member;
a first transmission selectively mounted to a first end of said frame; and, at least a first ground engaging wheel operatively attached to said transmission; and,
wherein said frame is adapted to selectively receive a second engine in replacement of said first engine, wherein said first engine is substantially different from said second engine.

2. The vehicle of claim 1, further comprising:
an engine-receiving member for use in selectively receiving one of said first and second engines, wherein said frame member is adapted to selectively fixedly receive said engine-receiving member at a plurality of positions along said frame member;
vibration isolating means communicating said one of said first and second engines to said engine-receiving member; and,
fastening means for use in operatively fastening said one of said first and second engines to said engine-receiving member.

3. The vehicle of claim 2, further comprising:
at least a first transmission mounting plate fixedly attached to said frame member, said at least a first transmission mounting plate adapted to receive said first transmission.

4. The riding mower of claim 3, wherein said at least a first transmission mounting plate is also adapted to selectively receive a second transmission in replacement of said first transmission, wherein said second transmission is substantially different from said second transmission.

5. The vehicle of claim 4, wherein said at least a first transmission mounting plate includes at least first and second sets of holes for use in selectively attaching one of said first and second transmissions to said at least a first transmission mounting plate.

6 The vehicle of claim 3, further comprising:
at least a second transmission mounting plate fixedly attached to said frame member in replacement of said first transmission mounting plate, said at least a second transmission mounting plate adapted to receive a second transmission in replacement of said first transmission, wherein said first transmission is substantially different from said second transmission.

7. The vehicle of claim 6, further comprising:
a mower deck fixedly attached to said frame member.

8. The vehicle of claim 7, further comprising:
a seat adapted to receive an associated vehicle operator.

9. A vehicle, comprising:
a frame member;
a first engine selectively received by said frame member;
a first transmission selectively mounted to a first end of said frame; and, at least a first ground engaging wheel operatively attached to said transmission; and,
wherein said frame is adapted to selectively receive a second transmission in replacement of said first transmission, wherein said first transmission is substantially different from said second transmission.

10. The vehicle of claim 9, further comprising:
at least a first transmission mounting plate fixedly attached to said frame member, said at least a first transmission mounting plate adapted to selectively fixedly receive one of said first and second transmissions.

11. The vehicle of claim 10, wherein said at least a first transmission mounting plate includes at least first and second sets of holes for use in selectively attaching said one of said first and second transmissions to said transmission mounting plate.

12. The vehicle of claim 9, further comprising:
at least a first transmission mounting plate fixedly attached to said frame member, said at least a first transmission mounting plate adapted to receive said first transmissions; and,
at least a second transmission mounting plate fixedly attached to said frame member in replacement of said first transmission mounting plate, said at least a second transmission mounting plate adapted to receive said second transmissions.

13. The vehicle of claim 12, further comprising:
an engine-receiving member for use in receiving said first engine, wherein said frame member is adapted to selectively fixedly receive said engine-receiving member at a plurality of positions along said frame member;
vibration isolating means communicating said first engine to said engine receiving member; and,
fastening means for use in operatively fastening said first engine to said engine receiving member.

14. The riding mower of claim 13, wherein said engine-receiving member is adapted to receive a second engine in replacement of said first engine, wherein said second engine is substantially different from said second engine.

15. The vehicle of claim 14, further comprising:
a mower deck fixedly attached to said frame member.

16. The vehicle of claim 15, further comprising:
a seat adapted to receive an associated vehicle operator.

17. A method of adjusting the drive train of vehicle, the steps comprising:
providing:
a first engine;
first and second transmissions;
a frame member adapted to receive said first engine, said frame member also adapted to receive one of said first and second transmissions;
at least a first ground engaging wheel;
selecting one of said first and second transmissions; and,
operatively attaching said one of said first and second transmissions to said frame member.

18. A method of making a vehicle, the steps comprising:
providing:
a first transmission;
first and second engines;
a frame member adapted to receive said first transmission, said frame member also adapted to receive one of said first and second engines;
at least a first ground engaging wheel;
selecting one of said first and second engines; and,
operatively attaching said one of said first and second engines to said frame member.
